(19) United States
(12) Patent Application Publication
(10) Pub. No.: US 2025/0094970 A1
(43) Pub. Date: Mar. 20, 2025

(54) DIGITAL CUSTODY AND DIGITAL CUSTODY TRANSACTIONS

(71) Applicant: Baultavo, Inc., New York, NY (US)

(72) Inventor: Keith D. Kourie, Johannesburg (ZA)

(21) Appl. No.: 18/963,448

(22) Filed: Nov. 27, 2024

Related U.S. Application Data
(63) Continuation of application No. PCT/IB2023/055412, filed on May 26, 2023.
(63) Continuation of application No. PCT/IB2023/059344, filed on Sep. 21, 2023.
(63) Continuation of application No. PCT/IB2023/062470, filed on Dec. 11, 2023.
(60) Provisional application No. 63/346,461, filed on May 27, 2022.
(60) Provisional application No. 63/409,378, filed on Sep. 23, 2022.
(60) Provisional application No. 63/432,520, filed on Dec. 14, 2022.

(51) Int. Cl. G06Q 20/38; G06Q 20/40

(52) U.S. Cl. CPC G06Q 20/3829; G06Q 20/40145

(57) ABSTRACT

Various systems, devices, methods and computer readable media are disclosed. One exemplary implementation may include a security device, which may include a body complying to an ISO/IEC 7810 standard, a security controller (SC), operable to generate at least one secure random number from a seed generated from a feature vector of a user, and a Bluetooth interface, connected to the security controller, operable to exchange data between the security controller and an external matched Bluetooth interface. Another exemplary implementation may involve a method of initiating an asset send transaction in a blockchain custody system. Such illustrative method may include receiving an encrypted initiate send transaction message from a remote initiator, the remote initiator being the holder of a biometrically enabled security device, receiving an encrypted authorize/verify send transaction message from a remote authorizer, executing a sent transaction in accordance with the encrypted initiate send transaction message, and/or completing the send transaction on the blockchain custody system. A further exemplary implementation may involve a method of initiating an asset receive transaction on a biometrically enabled receiving security device. Such illustrative method may include receiving an encrypted initiate receive transaction message from a remote initiator, the remote initiator being the holder of a biometrically enabled security device, receiving at least one encrypted authorize/verify receive transaction message from a remote authorizer, executing a receive transaction in accordance with the encrypted initiate and authorize/verify receive transaction message on a biometrically enabled receiving security device in the blockchain custody system, and/or completing the receive transaction on the biometrically enabled receiving security device in the blockchain custody system.

### CROSS-REFERENCE TO RELATED APPLICATION(S) INFORMATION

This application is a bypass continuation of (i) PCT Int'l application No. PCT/IB2023/055412, Int'l filing date 26 May 2023, published as WO2023/228140A2, which claims benefit/priority of U.S. provisional application No. 63/346,461, filed 27 May 2022, of (ii) PCT Int'l application No. PCT/IB2023/059344, Int'l filing date 21 Sep. 2023, published as WO2024/062411A2, which claims benefit/priority of U.S. provisional application No. 63/409,378, filed 23 Sep. 2022, and of (iii) PCT Int'l application No. PCT/IB2023/062470, Int'l filing date 11 Dec. 2023, published as WO2023/127208A1, which claims benefit/priority of U.S. provisional application No. 63/432,520, filed 14 Dec. 2022, all of which are incorporated herein by reference in entirety.

### BACKGROUND

### Field(s)

This present innovations relate, in a first embodiment, to digital custody and, in second and third embodiments, to digital custody transactions. In particular, the present innovations relate, in the first embodiment, to a security device, to a security module, to a security vault and to a method of accessing a security device, and, in the second embodiment, to a method of initiating an asset send transaction, and, in the third embodiment, to a method of initiating an asset receive transaction.

### Description of Related Art

Modern digital transaction systems rely on blockchain technology to facilitate digital transactions. This technology is used increasingly in real world transactions to ensure independently verified secure transactions. Use of blockchain technology leads to the need for curation of blockchain assets by independent third parties.

The most significant growth in blockchain transactions has been in the market of smaller entities, which implies reduced unit value/increased volume transactions.

The adoption of blockchain assets has been in all goods and services markets such as legal firms, accounting firms, luxury goods market, exclusive art and the like.

However, as any blockchain asset is singular, the custody thereof is of critical importance and a combination of software and hardware custody systems are often preferred. The disclosed technology therefore provides technical solutions regarding, inter alia, providing a combination hardware/software custody system that is safe and secure, not vulnerable to attacks from hackers, only accessible by authorized parties and which provides adequate backup in event of failure.

With regard to the second and third embodiment, it is to be appreciated that the disclosed technology may involve method(s) of initiating asset send and/or receive transactions. However, to assist in the understanding of the specification, definitions are provided for the software/hardware on which the method is implemented. Generic terms used in the field of blockchain technology will not be explained as it is assumed that the addressee of the patent is a person skilled in the art of blockchain technology. Such generic terms should be given their ordinary meaning in this relevant field of technology.

A blockchain custody system is a software/hardware system on which Blockchain transactions can be stored and accessed. Known access control methods are implemented to ensure blockchain transactions are only accessible by authorized users of the blockchain custody system.

The blockchain custody system includes a system on which is stored any one or more of: a plurality of organizations being listed for operation and access by authorized users; each organization has stored under it a number of accounts being listed for operation and access by authorized users; each account has stored under it a number of wallets being listed for operation and access by authorized users; each wallet has stored under it a number of assets being listed for operation and access by authorized users; and each asset has stored under it a plurality of private and public keys/addresses representing a balance stored on a blockchain.

Users are defined as any one of: a remote initiator; a remote authorizer; an asset owner is a person or entity which owns the asset of which the balance is stored on the blockchain.

Policy rules are predefined rules or criteria that each type of transaction have to conform to.

A biometrically enabled security device is a device comprising: a biometric reader operable to generate a seed of a secure random number in the form of an asymmetric cryptographic key pair known as Public/Private keys, the seed being generated from a biometric feature vector of a person; and a security controller operable to generate at least one secure random number from the seed generated by the biometric reader.

### OVERVIEW

### First Embodiments

According to one aspect of the invention there is provided a security device, which includes: a body complying to an ISO/IEC 7810 standard; a security controller, operable to generate at least one secure random number from a seed generated from a feature vector of a user; a Bluetooth interface, connected to the security controller, operable to exchange data between the security controller and an external matched Bluetooth interface.

The term secure controller (in the drawings)/security controller and secure element may be used interchangeably and refers to the same device.

According to another aspect of the invention, there is provided a security device, which includes: a plurality of security controllers, each of which is operable to generate at least one secure random number from a seed generated from a feature vector of a user; universal asynchronous receiver/transmitter interface (UART), the interface operable to exchange data between the security controller and a matched interface device; and one or more Micro Controller Units (MCUs), connected to the plurality of security controllers.

The security device may include a biometric reader, operable to generate the seed for the secure random number, the seed being generated from a feature vector of a user. The user may be a person and the feature vector may thus be a homomorphically encrypted feature vector of a biometric feature of a person.

The security controller (SC) may be a Common Criteria Evaluation Assurance Level 6+ High (CC EAL 6+ High) enabled security controller.

The biometric reader may be a fingerprint scanner, a face scanner, a pupil scanner, or the like. The biometric reader may be operable to generate and verify a feature vector of a biometric feature of a person. In one embodiment, the fingerprint scanner may be an FCP1323 T-Shape touch sensor.

In addition to the Bluetooth interface, the security device may include any one or more of an ISO/IEC 7816 compliant interface (contact interface), an ISO/IEC 14443 compliant interface (contactless interface), a Universal Serial Bus (USB) compliant interface, universal asynchronous receiver/transmitter compliant interfaces (UART), or the like, additionally connected to the security controller, the interface operable to exchange data between the security controller and a matched interface device. The ISO/IEC 7816 (Contact) and ISO/IEC 14443 (Contactless) interfaces may be integrated into the security controller.

The security device may include a display connected to the processor, operable to display data from the processor. The display may be in the form of an E-Ink display.

The security device may include an Apple Authentication coprocessor, operable to authenticate an accessory running iOS 10.0.2 or later.

The security device may include a Micro Controller Unit (MCU). The MCU may be connected to the biometric reader, to the display, to the Bluetooth interface, to the USB/UART interface, to the Apple Authentication coprocessor and to an optional light emitting diode (LED). The LED may be a tri-colour LED.

The secure random number may be in the form of an asymmetric cryptographic key pair known as Public/Private keys. The seed may be in the form of a homomorphically encrypted feature vector of a user. The feature vector may be stored in a memory of the security device, referred to as a master seed key.

The security controller may be connected to the MCU, to the contactless interface and to the contact interface.

The security controller may be arranged as the master processor and the MCU may be arranged as the slave processor.

The MCU and SC may be operable to manage the seed key and private and public key pairs, including any one of the steps of: creating, storing and using of a master seed key; creating, storing and using blockchain private and public key pairs; creating a backup of the master seed key; creating a backup of feature vectors of a user; creating a backup of feature vectors of successor users; and retrieving a master seed key by means of the feature vector of a user.

The MCU and SC may be operable to manage the biometric scanner, including any one of the steps of: creating multiple biometric feature vectors; enrolling multiple biometric feature vectors; comparing scanned biometric features with previously stored biometric feature vectors; and updating previously stored biometric features with newly scanned biometric feature vectors.

The above steps may be employed for normal biometric features or for biometric features to be used during duress situations.

The above steps may be employed for biometric features of normal users or for biometric features of successors or normal users.

The MCU and SC may be operable to control transaction flow, including any one of the steps of: flow and state control of security device transactions; application of feature vectors to transactions; and manual authentication of transactions.

The MCU and SC may be operable to control communication with remote processors via any one of the interfaces, including any one of the steps of: creating encrypted data messages, such as hashes, digital signatures and message authentication codes (MACs); receiving and decrypting and/or validating and/or authenticating messages and data; generating and management of secure, once-off symmetric and/or asymmetric keys, such as Derived Unique Key Per Transaction (DUKPT) keys.

The security controller may be operable to encrypt a data message by means of a public key in combination with a feature vector of a user. The security controller may be operable to decrypt a data message by means of a private key in combination with a feature vector of a user.

The data exchanged between the security controller and a matched interface may include an encryption key. For example, the encryption key may be the public key that is to be forwarded to a security application.

The MCU and SC may be operable to control the display.

The MCU and SC may be operable to control the interfaces.

The MCU and SC may be operable to control the communication transport layers for devices connected via the interfaces.

The security device may be operable to run an Europay, Mastercard, Visa (EMV) and Amex based payment application, operable to communicate with matched EMV and Amex enabled terminals. It is to be appreciated that these card formats are non-exhaustive.

The security device may include a power management system/power system, a power harvesting system and a rechargeable battery, connected to the power management system.

The security device may be operable via the Bluetooth interface to communicate with a paired Bluetooth device to exchange data between the security controller and security device and the paired Bluetooth device.

In this instance the security device may be used in combination with an API on a external device to encrypt/decrypt data messages and to provide a feature vector of a user when requested by the external device.

It is to be appreciated that the security device may be operated while connected to an external network (hot) or may be operated when not connected to an external network (cold).

According to another aspect of the invention, there is provided a security module, which includes: a controller in the form of a single-board computer; at least one Universal Serial Bus (USB)/UART hub to which a number of USB/UART devices are connectable; an Ethernet interface to which a plurality of Ethernet devices are connectable; a plurality of security devices as described connected to the at least one USB/UART hub.

The security module may include a plurality of USB/UART hubs, each of the plurality of USB/UART hubs being connectable to a plurality of USB/UART devices.

In one embodiment the security module may include (17) seventeen USB/UART hubs. Each USB/UART hub may be connectable to six USB/UART devices. In this embodiment 6 (six) security devices may be connected to each of the USB/UART hubs to render a total of 102 security devices connected into the security module. The security devices may be removably connectable to the security module. It is to be appreciated that the number of devices connected to the USB/UART hubs may be different depending on the protocols employed.

It is to be appreciated that each of the security devices may be uniquely addressable by the controller via the Ethernet interface. It is to be appreciated that the security device functionality as described above may be available when the plurality of security devices are connected together as described above.

According to another aspect of the invention, there is provided a security vault, which includes a plurality of security modules as described, connected via an Ethernet interface.

In one embodiment 7 (seven) security modules may be connected to render a total of 714 connected security devices.

The invention extends to a method of accessing a security device as described, which includes: providing a plurality of security devices connected together, as described; addressing a single security device in the security vault as described; writing and reading data from the security device via an Ethernet interface and a USB/UART interface.

### Second Embodiments

According to one aspect of the invention, in a blockchain custody system, there is provided a method of initiating an asset send transaction, which includes: receiving an encrypted initiate send transaction message from a remote initiator, the remote initiator being the holder of a biometrically enabled security device; receiving an encrypted authorize/verify send transaction message from a remote authorizer; executing a sent transaction in accordance with the encrypted initiate send transaction message; and completing the send transaction on the blockchain custody system.

The method may include prior to receiving an encrypted initiate send transaction message from a remote initiator the step, by a remote initiator, of initiating the asset send transaction.

The step of initiating the asset send transaction by a remote initiator may include the following sequential steps: a remote initiator logs into a custody system; a remote initiator selects an organization from a list of organizations to which the remote initiator has access; a remote initiator selects an account from a list of accounts to which the remote initiator has access of the selected organization; a remote initiator selects a wallet from a list of wallets to which the remote initiator has access of the selected accounts to which the remote initiator has access; a remote initiator selects an asset from a list of assets to which the remote initiator has access of the selected wallets to which the remote initiator has access; a remote initiator is presented with a balance and any other relevant information of the selected asset; a remote initiator enters all relevant information required to which the selected asset should be transferred including, such as a destination address and an amount/value; and a remote initiator confirms/authorizes the asset send transaction.

The step of initiating the asset send transaction may include the step of displaying customizable fields to a remote initiator.

The step of entering a destination address to which the selected asset should be transferred may include any one of: entering the destination address manually; scanning the destination address which is presented in the form of a unique visual code, such as a QR code; selecting the destination address from a pre-populated list of destination addresses.

The step of initiating the asset send transaction may include the additional step of displaying a transaction fee and any other fees after the remote initiator entered an amount of the selected asset that should be transferred.

The step of initiating the asset send transaction may include the additional step of entering custom field values.

The method may include, prior to receiving an encrypted authorize/verify send transaction message from a remote authorizer the step, by at least one remote authorizer, of authorizing the asset send transaction.

The step of authorizing the asset send transaction may include the following sequential steps: a remote authorizer logs into a custody system; a remote authorizer selects an organization from a list of organizations to which the remote authorizer has access; a remote authorizer selects a pending send transaction from a list of pending send transactions; a remote authorizer views details of the selected pending send transaction; a remote authorizer then confirms/authorizes the send transaction.

The step of authorizing the asset send transaction may include the additional step of displaying custom field values to the remote authorizer. The step of authorizing the asset send transaction may then also include the step of entering custom field values.

The step of executing a sent transaction in accordance with the encrypted initiate send transaction message may include the following sequential steps: the blockchain custody system receives the encrypted initiate send transaction; the blockchain custody system receives the encrypted authorize verify send transaction messages; the blockchain custody system checks the send transaction against policy rules and predefined values; the blockchain custody system then sends the encrypted messages to an asset owner's biometrically enabled security device (being hosted on a security module in the blockchain custody system); the blockchain custody system receives the signed blockchain transaction from the asset owner's biometrically enabled security device; the blockchain custody system sends the signed blockchain transaction to remote processors to be mined.

The step of executing a send transaction may include the intermediary steps, between the sending of the encrypted messages to the initiator's biometrically enabled security device and the receiving of the signed blockchain transaction from the asset owner's biometrically enabled security device, of the owner's biometrically enabled security device authenticates and validates the initiator's encrypted message and other encrypted messages and checks the send transaction against policy rules and predefined values; and the owner's biometrically enabled security device signing the blockchain transaction using the encrypted messages.

The step of completing the send transaction on the blockchain custody system in the method of initiating an asset send transaction may include the following sequential steps: monitoring the blockchain transaction being sent for mining until the required threshold number of transaction confirmations have been met; marking the send transaction as complete once the required number of transaction confirmations has been met.

### Third Embodiments

According to third embodiments/aspects of the innovations herein, in a blockchain custody system, there is provided an exemplary method of initiating an asset receive transaction on a biometrically enabled receiving security device, which may include: receiving an encrypted initiate receive transaction message from a remote initiator, the remote initiator being the holder of a biometrically enabled security device; receiving at least one encrypted authorize/verify receive transaction message from a remote authorizer; executing a receive transaction in accordance with the encrypted initiate and authorize/verify receive transaction message on a biometrically enabled receiving security device in the blockchain custody system; and completing the receive transaction on the biometrically enabled receiving security device in the blockchain custody system.

The method may include prior to receiving an encrypted initiate receive transaction message from a remote initiator the step, by a remote initiator, of initiating the asset receive transaction.

The step of initiating the asset receive transaction by a remote initiator may include the following sequential steps: a remote initiator logs into a custody system by means of a biometrically enabled security device; a remote initiator selects an organization from a list of organizations to which the remote initiator has access; a remote initiator selects an account from a list of accounts to which the remote initiator has access of the selected organization; a remote initiator selects a wallet from a list of wallets to which the remote initiator has access of the selected accounts to which the remote initiator has access; a remote initiator selects an asset from a list of assets to which the remote initiator has access of the selected wallets to which the remote initiator has access; a remote initiator is presented with an asset balance and any other relevant information of the selected asset; and a remote initiator confirms/authorizes the asset receive transaction on a biometrically enabled receiving security device.

The step of initiating the asset receive transaction may include the step of displaying and editing customizable fields to a remote initiator.

The step of initiating the asset receive transaction may include the additional step of displaying custom field values.

The additional step of displaying custom field values may display custom field values for a particular secure account.

The step of initiating the asset receive transaction may then include the additional step of entering and/or selecting custom field values after the step of displaying custom field values.

The step of authorizing the asset receive transaction may include the following sequential steps: a remote authorizer logs into a custody system by means of a biometrically enabled security device; a remote authorizer selects an organization from a list of organizations to which the remote authorizer has access; a remote authorizer selects a pending receive transaction from a list of pending receive transactions; a remote authorizer view details of the selected pending receive transaction; a remote authorizer then confirm/authorize the receive transaction by means of a biometrically enabled security device.

The step of authorizing the asset receive transaction may include the additional step of displaying custom field values to the remote authorizer. The step of authorizing the asset receive transaction may then also include the step of entering custom field values.

The step of executing a receive transaction in accordance with the encrypted initiate receive transaction message may include the following sequential steps: the blockchain custody system receives the encrypted initiate receive transaction; the blockchain custody system receives the encrypted authorize/verify receive transaction messages; optionally, the blockchain custody system checks the receive transaction against policy rules and predefined values; an executor logs onto the custody system by means of a biometrically enabled security device; the executor selects an organization from a list of organizations to which the executor has access; the executor selects a pending Authorized/Verified receive transaction to execute; optionally, custom field values are displayed to the executor; details of the pending authorized/verified receive transaction including the destination address is displayed to the executor; optionally, the executor enters optional custom field values for the receive transaction; the blockchain custody system sends encrypted messages and data to the biometrically enabled receiving security device (that is to receive the blockchain asset); the biometrically enabled receiving security device authenticates and verifies all data messages and checks the receive transaction against policy rules and predefined values; following successful authentication and verification of the encrypted messages and data, the biometrically enabled receiving security device internally creates a destination address and returns this destination address to the blockchain custody system; and the executor generates the blockchain transaction on the relevant system.

An executor is defined as a role which has permission to execute a previously authorized/verified receive transaction.

The step of completing the receive transaction on the blockchain custody system in the method of initiating an asset receive transaction may include the following sequential steps: if the transaction ID was entered by the executor, monitoring the blockchain transaction being sent for mining until the required threshold number of transaction confirmations have been met; either marking the receive transaction as complete once the required number of transaction confirmations have been met, or automatically marking the receive transaction as complete if the executor marked the receive transaction as complete.

The above embodiments and innovations are now described, by way of non-limiting examples, with reference to the accompanying figures.

### BRIEF DESCRIPTION OF THE FIGURES

In the figure(s):

FIG. 1 shows a schematic block diagram of a security device in accordance with one aspect of the invention;

FIG. 2 shows a schematic block diagram of a security module in accordance with another aspect of the invention;

FIG. 3 shows the security module of FIG. 2 operatively connected to a plurality of security devices of FIG. 1;

FIG. 4 shows a plurality of security modules of FIG. 3 connected in a security vault; and

FIG. 5 shows a schematic block diagram of a security device in accordance with another aspect of the invention.

FIG. 6 shows a high-level schematic flow diagram of a method of initiating an asset send transaction;

FIG. 7 shows a more detailed schematic flow diagram of the method of initiating an asset send transaction of FIG. 6;

FIG. 8 shows the steps of initiating the asset send transaction by a remote initiator in the method of FIG. 7;

FIG. 9 shows the steps of authorizing the asset send transaction in the method of FIG. 7;

FIG. 10 shows the steps of executing a sent transaction in the method of FIG. 7; and

FIG. 11 shows the steps of completing the send transaction in the method of FIG. 7.

FIG. 12 shows a high-level schematic flow diagram of a method of initiating an asset receive transaction;

FIG. 13 shows an implementation architecture of a blockchain custody system in accordance with one aspect of the invention;

FIG. 14 shows the steps of initiating the asset receive transaction by a remote initiator in the method of FIG. 12;

FIG. 15 shows the steps of authorizing the asset receive transaction in the method of FIG. 12;

FIG. 16 shows the steps of executing a receive transaction in the method of FIG. 12; and

FIG. 17 shows the steps of completing the receive transaction in the method of FIG. 12.

In the figures, like reference numerals denote like parts of the invention unless otherwise indicated.

### DETAILED DESCRIPTION OF ILLUSTRATIVE IMPLEMENTATIONS

### First Embodiments

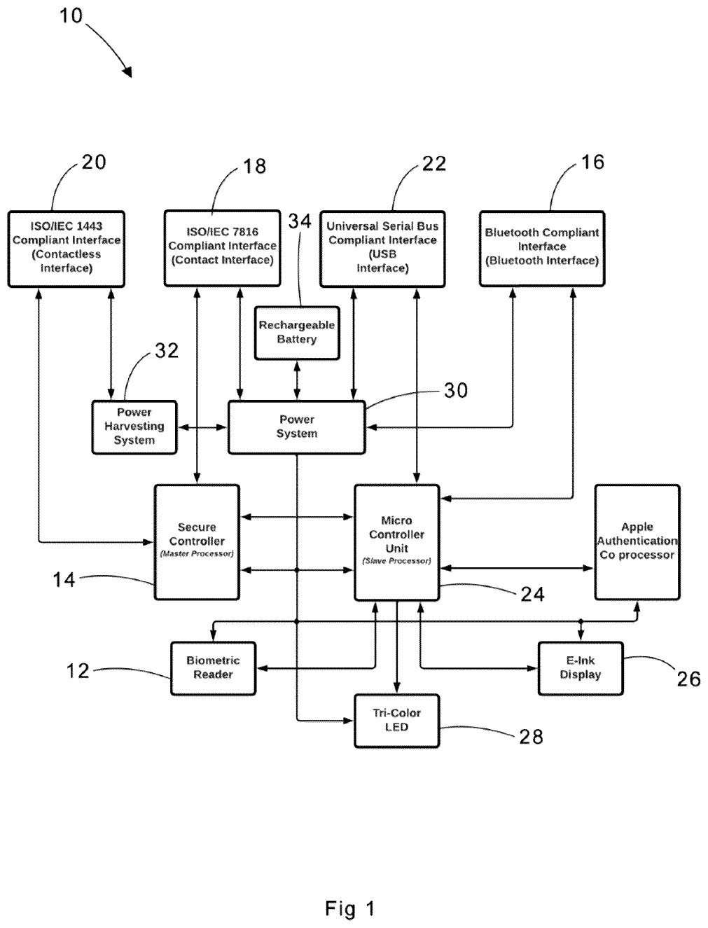

In FIG. 1 a security device (10) is shown, which includes a body (not shown) complying to an ISO/IEC 7810 standard.

This example is described where the user of the security device(s) is a natural person. However, it is to be appreciated that the user can also be a legal entity that might not have biometric features, such as fingerprints. In such an instance the feature vector will be of other features of the user. In a practical application the users will be a combination of natural persons and legal entities.

The security device (10) includes a biometric reader (12), operable to generate a seed of a secure random number, the seed being generated from a biometric feature vector of a person. The security device (10) includes a security controller (14), operable to generate at least one secure random number from the seed generated by the biometric reader, a Bluetooth interface (16), operatively connected to the security controller (14), operable to exchange data between the security controller and/or the micro controller unit and an external matched Bluetooth interface (not shown).

The security controller (SC) (14) in this example is a Common Criteria Evaluation Assurance Level 6+ High (CC EAL 6+ High) enabled security controller.

The biometric reader (12) in this example is a fingerprint scanner operable to generate and verify a homomorphically encrypted feature vector of a fingerprint of a person. In this example, the fingerprint scanner is an FCP1323 T-Shape touch sensor. The fingerprint scanner (12) includes a tap detector, operable to detect pulsed inputs from users, thereby to construct a security integer string.

In addition to the Bluetooth interface (16), the security device (10) includes an ISO/IEC 7816 compliant interface (contact interface) (18), an ISO/IEC 14443 compliant interface (contactless interface) (20), a Universal Serial Bus (USB) compliant interface (22) operatively connected to the security controller (14) (via an MCU (24)), the interface operable to exchange data between the security controller and/or the micro controller unit and a matched interface device.

The security device (10) further includes a Micro Controller Unit (MCU) (24) which is connected to the security controller (14). In this example, the MCU (24) is electrically connected to the biometric reader (12), to an e-Ink display (26), to the Bluetooth interface (16), to the USB interface (22) and to an optional tri-colour Light Emitting Diode (LED) (28).

The security controller (14) is electrically connected to the contactless interface (20) and contact interface (18).

The security device (10) may include an Apple Authentication coprocessor (not shown), operable to authenticate an accessory running iOS 10.0.2 or later.

The secure random number described above in this example is an asymmetric cryptographic key pair known as Public/Private keys. The seed is therefore in the form of the homomorphically encrypted feature vector of the fingerprint of a person. The feature vector may be stored in a memory (not shown) of the security device (10), referred to as a master seed key.

The security controller (14) in this example is arranged as the master processor and the MCU is arranged as the slave processor.

The security device (10) further includes a power management system/power system (30), a power harvesting system (32) and a rechargeable battery (34), connected to the power management system (30).

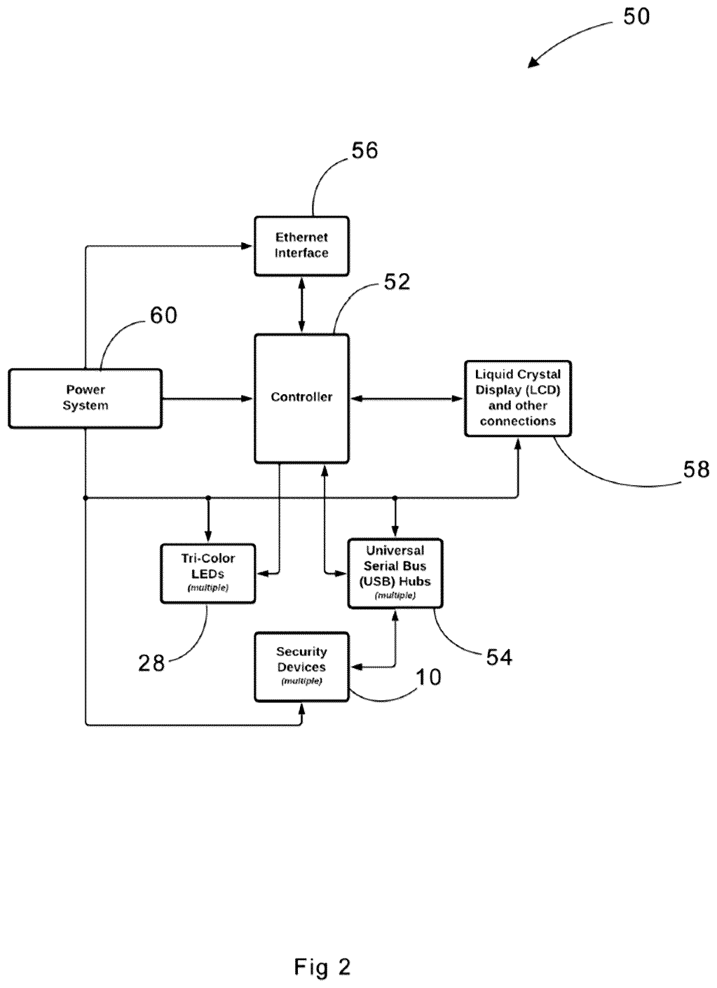

In FIG. 2 a security module (50) in accordance with another aspect of the invention is shown. The security module (50) includes a controller in the form of a single-board computer (52), a Universal Serial Bus (USB) hub (54) to which a number of USB devices are connectable, an Ethernet interface (56) to which a plurality of Ethernet devices are connectable, a Liquid Crystal Display (LCD) (58) and a power system (60). It is to be appreciated that the USB hub (54) can be replaced with another communication hub such as a universal asynchronous receiver/transmitter interface (UART) hub for connecting to security devices that is not USB enabled, but UART enabled as described below. The USB hub and UART hub will be broadly referred to as communication hubs.

The USB hub (54) is connectable to 102 (hundred and two) security devices (10) connected thereto by means of their USB interfaces (22). The single-board computer (52) are operatively connected to a number of tri-colour LED's (28) of the security devices (10) connected via the USB interface (22).

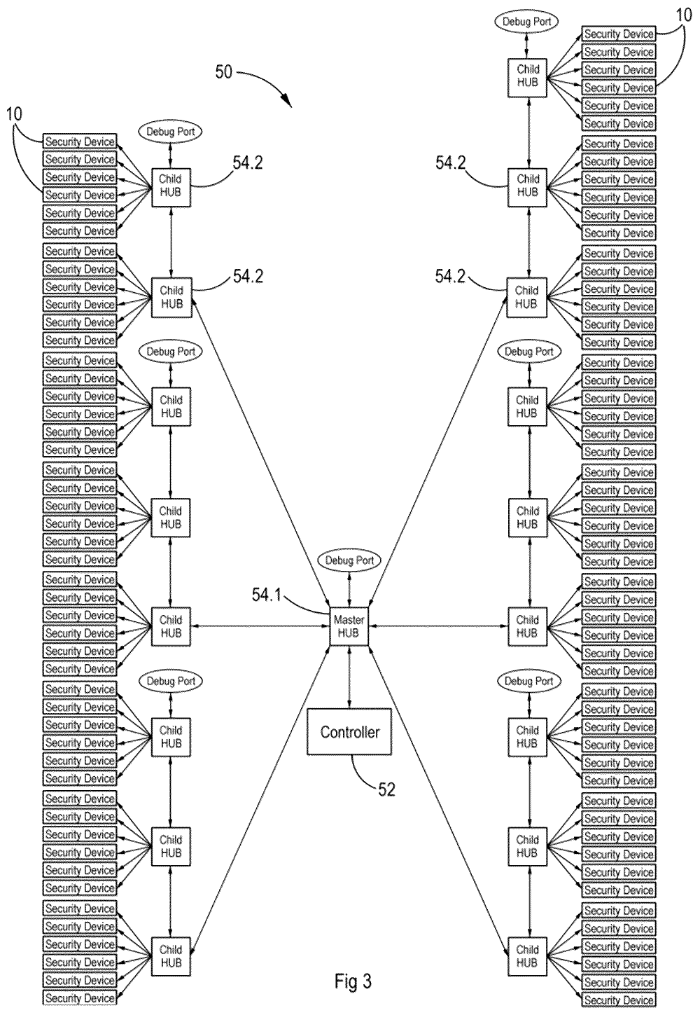

As can be seen in FIG. 3, the security module (50) includes 17 (seventeen) USB hubs. Each USB hub is connected to six USB devices. In this example 6 (six) security devices (10) are connected to each of the USB hubs to render a total of 102 security devices (10) connected to the security module (50). The security devices (10) may be removably connectable to the security module (50). In this example, the security devices are in the form of ISO/IEC 7810 standard cards.

The USB hubs (54) in FIG. 3 are either arranged as a master USB hub (54.1) or a child USB hub (54.2).

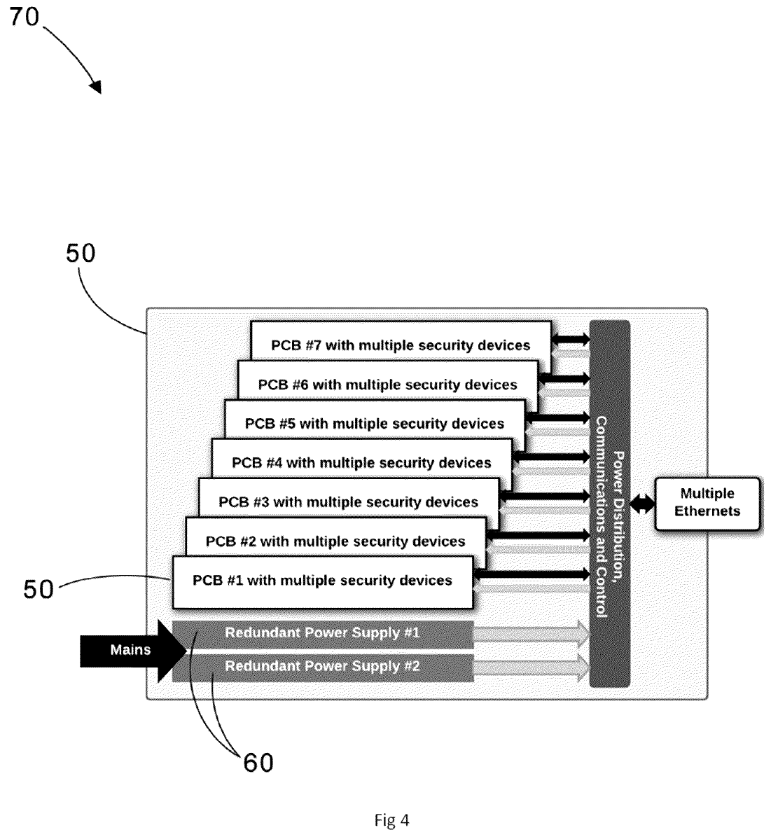

In FIG. 4, a security vault (70) is seen, which includes 7 (seven) security modules (50) as described, each of which is connected via an Ethernet interface. Each of the security modules (50) are uniquely addressable via their Ethernet Interfaces (56) and each of the security devices (10) connected via the USB hubs (54) are in turn uniquely addressable via their USB interfaces (22). The power system (60) in the security vault (70) powers also the security modules (50).

It is to be appreciated that each of the security devices (10) being uniquely addressable, via the Ethernet interfaces (56) and USB hubs (22) operates as an independent unit, with functionality which is described below in more detail

The MCU (24) and SC (22) combination of each security device (10) is operable to manage the seed key and private and public key pairs by means of the following functionality:
creating, storing and using of a master seed key;
creating, storing and using blockchain private and public key pairs;
creating a backup of the master seed key;
creating a backup of feature vectors of a user;
creating a backup of feature vectors of successor users; and
retrieving a master seed key by means of the feature vector of a user.

The MCU (24) and SC (22) combination of each security device (10) is operable to manage the biometric scanner (12), by means of the following functionality:
creating multiple biometric feature vectors;
enrolling multiple biometric feature vectors;
comparing scanned biometric features with previously stored biometric feature vectors;
updating previously stored biometric features with newly scanned biometric feature vectors.

The above functionality can be employed for normal biometric features or for biometric features to be used during duress situations. Moreover, the above functionality can be employed for biometric features of normal users or for biometric features of successors or normal users.

The MCU (24) and SC (22) combination of each security device (10) is operable to manage transaction flow, by means of the following functionality:
flow and state control of security device transactions;
application of feature vectors to transactions; and
manual authentication of transactions.

The MCU (24) and SC (22) combination of each security device (10) is operable to manage communication with remote processors via any one of the interfaces, by means of the following functionality:
creating encrypted data messages, such as hashes, digital signatures and Message Authentication Codes (MACs);
receiving and decrypting and/or validating and/or authenticating messages and data;
generating and management of secure, once-off symmetric and/or asymmetric keys, such as Derived Unique Key Per Transaction (DUKPT) keys.

The security controller (14) of each security device (10) is operable to encrypt a data message by means of a public key in combination with a feature vector of a user and is also operable to decrypt a data message by means of a private key in combination with a feature vector of a user.

The data exchanged between the security controller (14) of each security device (10) and a matched interface may include an encryption key. For example, the encryption key may be the public key that is to be forwarded to a security application.

The MCU (24) and SC (22) combination of each security device (10) is further operable to control the display (26) and the interfaces (16, 18, 20, 22) on each respective security device (10) and is operable to control the communication transport layers for devices connected via the interfaces (16, 18, 20, 22).

Each security device (10) is operable to run a EMV based payment application and is operable to communicate with matched EMV enabled terminals.

Each security device (10) is operable via its Bluetooth interface (16) to communicate with a paired Bluetooth device to exchange data between the security device (10) a paired Bluetooth device allowing the security device (10) to be used in combination with an API on a external device to encrypt/decrypt data messages and to provide a feature vector of a user when requested by the external device.

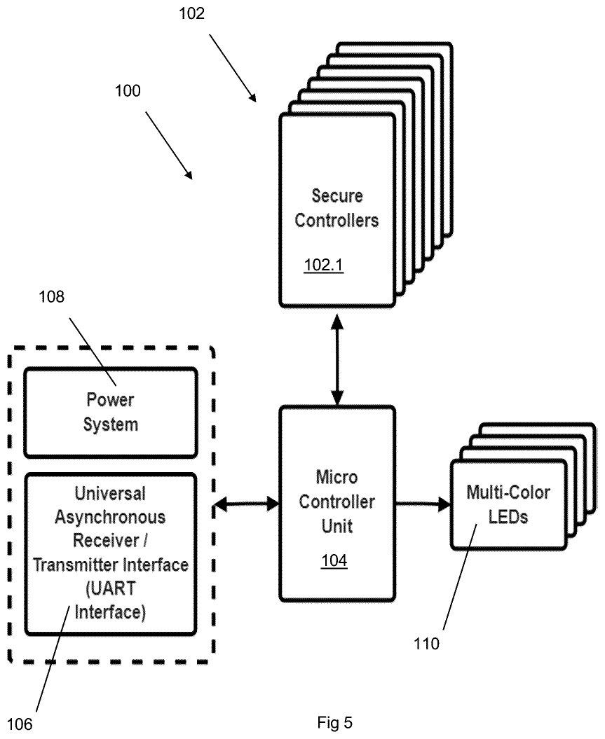

FIG. 5 shows a security device (100) in accordance with another aspect of the invention.

The security device (100) includes a plurality of security controllers (102.1 to 102.n), each of which is operable to generate at least one secure random number from a seed generated from a feature vector of a user. One Micro Controller Unit (MCU) (104) is connected to the plurality of security controllers (102). It is to be appreciated that more MCU (104) can be connected to the security controllers (102).

A universal asynchronous receiver/transmitter interface (UART) (106) is connected to the MCU (104) to exchange data between the security controllers (102) and an external matched interface device (not shown).

A power management system/power system (108) is provided to power the security device (100).

The security controllers (SC) (102) is Common Criteria Evaluation Assurance Level 6+ High (CC EAL 6+ High) enabled security controllers.

The security device (100) includes multi-colour LED's (110) that can indicate a status of the security device (100) or the security controllers (102).

In use, the security device (100) is operable to generate seeds for secure random numbers, the seeds being generated from feature vectors of users. The secure random numbers are in the form of an asymmetric cryptographic key pair known as Public/Private keys. The seeds are in the form of homomorphically encrypted feature vectors of users, which are stored in the memory of the security device, referred to as master seed keys.

The Micro Controller Unit (MCU) (104) and the security controllers (SCs) are operable to manage the seed keys and private and public key pairs, including any one of the steps of: creating, storing and using of a master seed key; creating, storing and using blockchain private and public key pairs; creating a backup of the master seed key; creating a backup of feature vectors of a user; creating a backup of feature vectors of successor users; and retrieving a master seed key by means of the feature vector of a user.

The Micro Controller Unit (MCU) (104) and the security controllers (SCs) (102) are operable to manage biometric features, including any one of the steps of: storing biometric feature vectors; updating previously stored biometric features with new biometric feature vectors; for biometric features to be used in normal situations; for biometric features to be used during duress situations; and for biometric features of successors or normal users.

The Micro Controller Unit (MCU) (104) and the security controllers (SCs) (102) are operable to control transaction flows, including any one of the steps of flow and state control of security device transactions; application of feature vectors to transactions; and manual authentication of transactions.

The Micro Controller Unit (MCU) (104) and the security controllers (SCs) (102) are operable to control communications with remote processors (not shown) via any one of the interfaces.

The functionality of the Micro Controller Unit (MCU) (104) and the security controllers (SCs) (102) includes any one of the steps of
creating encrypted data messages, such as hashes, digital signatures and message authentication codes (MACs);
receiving and decrypting and/or validating and/or authenticating messages and data; and generating and management of secure, once-off symmetric and/or asymmetric keys, such as Derived Unique Key Per Transaction (DUKPT) keys.

The security controllers (102) are operable to encrypt data messages by means of a public key in combination with feature vectors of a users.

The security controllers (102) are operable to decrypt data messages by means of a private key in combination with feature vectors of a users.

The Micro Controller Unit (MCU) (104) and the security controllers (SCs) (102) are operable to control the interfaces.

The Micro Controller Unit (MCU) (104) and the security controllers (SCs) (102) are operable to control the communication transport layers for devices (not shown) connected via the interfaces.

The security device (100) is used in combination with an API on an external device (not shown) to encrypt/decrypt data messages and to provide feature vectors of users when requested by the external device.

Overall, the disclosed technology provides novel security devices, security modules, security vaults and methods of accessing a security device, which provides substantial advantages over existing technology to facilitate secure custody of digital assets in a hardware format.

### Second Embodiments

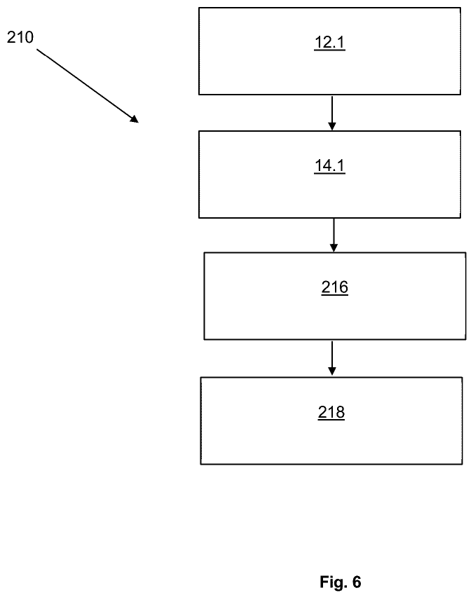

In FIG. 6 a schematic flow diagram of a method of initiating an asset send transaction (210) is shown.

In the method of initiating an asset send transaction (210), which is implemented in a blockchain custody system, the method is initiated by receiving an encrypted initiate send transaction message at (12.1) from a remote initiator, the remote initiator being the holder of a biometrically enabled security device.

The method then receives an encrypted authorize/verify send transaction message from at least one remote authorizer at (14.1), then executes a sent transaction in accordance with the encrypted initiate send transaction message at (216), and terminates by completing the send transaction on the blockchain custody system at (218).

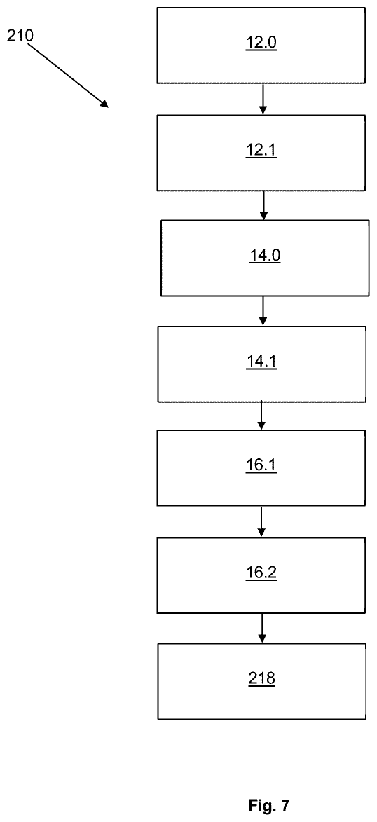

In FIG. 7 illustrates a more detailed flow diagram of the method of initiating an asset send transaction, as shown in FIG. 6.

The method that initiates at (12.1) with receiving an encrypted initiate send transaction message includes the step of initiating the asset send transaction at (12.0). The method may include, prior to receiving an encrypted authorize/verify send transaction message from the at least one remote authorizer at (14.1) the step, by at least one remote authorizer, of authorizing the asset send transaction at (14.0).

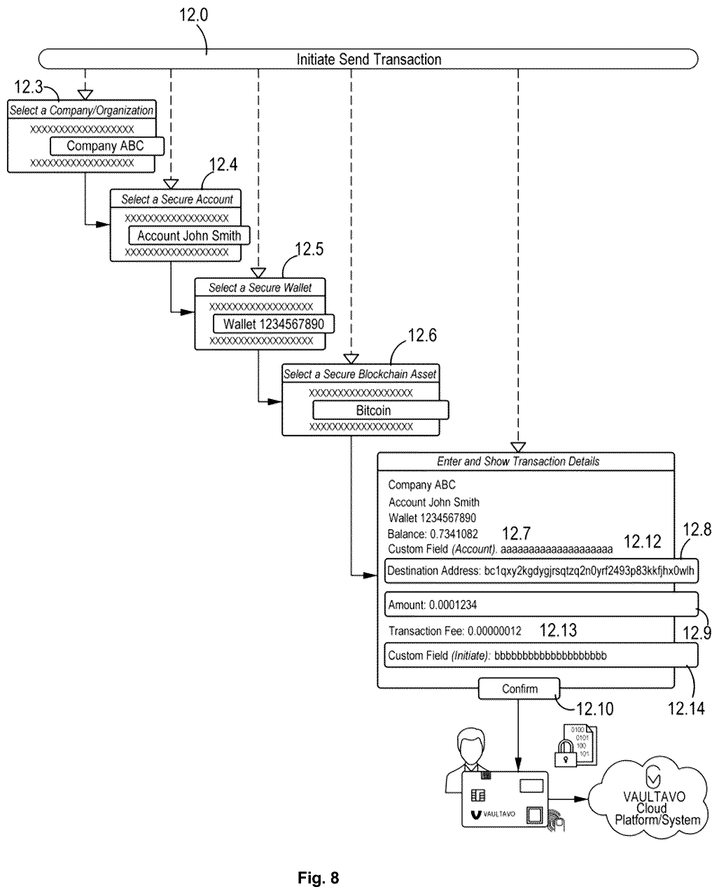

The step of initiating the asset send transaction (12.0) by a remote initiator includes the following sequential steps, that are shown in FIG. 8: at (12.2) a remote initiator logs into a custody system; at (12.3) the remote initiator selects an organization from a list of organizations to which the remote initiator has access; at (12.4) the remote initiator selects an account from a list of accounts to which the remote initiator has access of the selected organization; at (12.5) the remote initiator selects a wallet from a list of wallets to which the remote initiator has access of the selected accounts to which the remote initiator has access; at (12.6) the remote initiator selects an asset from a list of assets to which the remote initiator has access of the selected wallets to which the remote initiator has access; at (12.7) the remote initiator is presented with a balance and any other relevant information of the selected asset; at (12.8) and (12.9) the remote initiator enters all relevant information required to which the selected asset should be transferred such as a destination address and an amount/value a destination address to which the selected asset should be transferred; and at (12.10) the remote initiator confirms/authorizes the asset send transaction.

As can be seen, at (12.12), the step of initiating the asset send transaction includes displaying customizable fields to a remote initiator.

The step (12.8) of entering a destination address to which the selected asset should be transferred can include any one of: entering the destination address manually, scanning the destination address which is presented in the form of a unique visual code, such as a QR code, selecting the destination address from a pre-populated list of destination addresses.

As can be seen there is provided for the additional step at (12.13) of displaying a transaction fee and any other fees after the remote initiator entered an amount of the selected asset that should be transferred.

Furthermore, at (12.14) there is provided the additional step of entering custom field values.

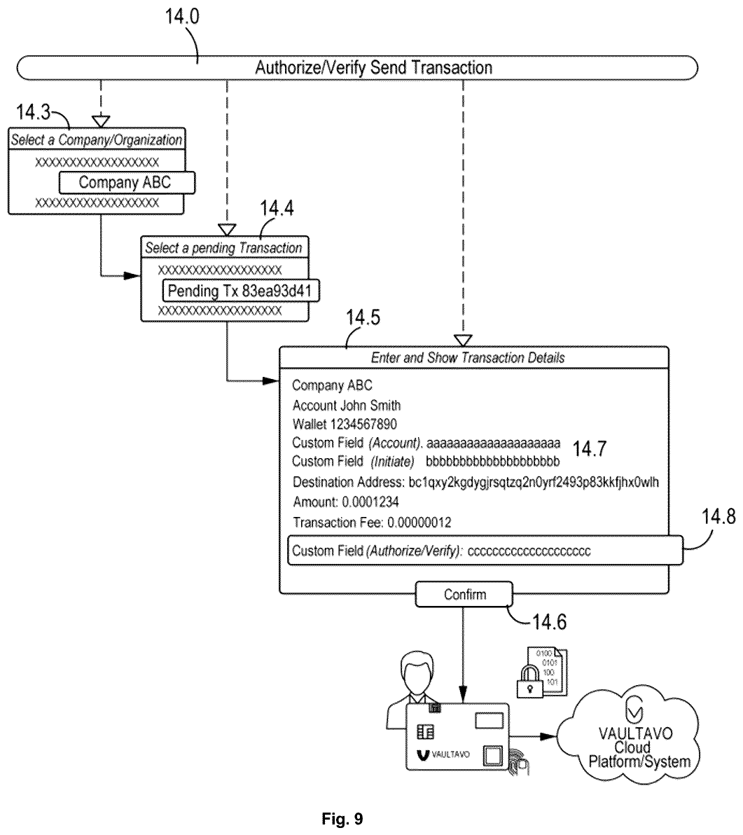

The step of authorizing the asset send transaction (14.0) includes the following sequential steps, that are shown in FIG. 9: at (14.2) a remote authorizer logs into a custody system; at (14,3) a remote authorizer selects an organization from a list of organizations to which the remote authorizer has access; at (14,4) a remote authorizer selects a pending send transaction from a list of pending send transactions; at (14.5) a remote authorizer view details of the selected pending send transaction; at (14.6) a remote authorizer then confirms/authorizes the send transaction; and/or at (14.7), the step of authorizing the asset send transaction includes the additional step of displaying custom field values to the remote authorizer. At (14.8) the step of authorizing the asset send transaction then also includes the step of entering custom field values.

It is to be appreciated, if multiple authorizers are to authorize a transaction, step (14.0) may be repeated multiple times.

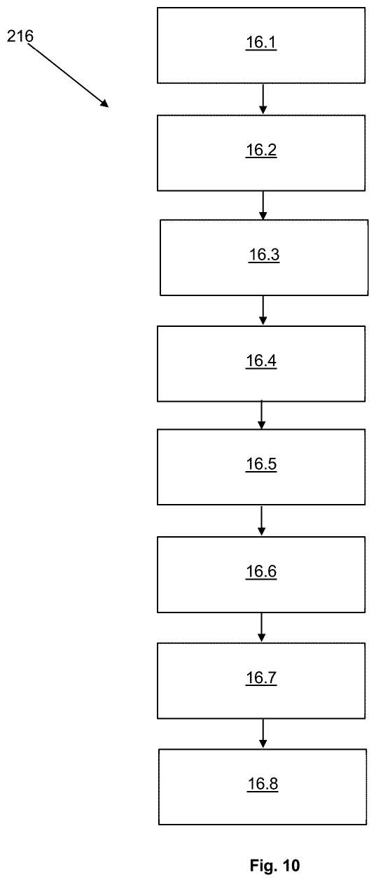

FIG. 10 shows the step of executing a sent transaction (216) in accordance with the method (210) in more detail.

The step of executing a sent transaction (216) in accordance with the encrypted send transaction message includes the following sequential steps: at (16.1) the blockchain custody system receives the encrypted initiate send transaction; at (16.2) the blockchain custody system receives the encrypted authorize verify send transaction messages; at (16.3) the blockchain custody system checks the send transaction against policy rules and predefined values; at (16.4) the blockchain custody system then sends the encrypted messages to the asset owner's biometrically enabled security device (being hosted on a security module in the blockchain custody system); at (16.5) the asset owner's biometrically enabled security device authenticates and validates the initiator's encrypted message and other encrypted messages and checks the send transaction against policy rules and predefined values; at (16.6) the asset owner's biometrically enabled security device signs the blockchain transaction using the encrypted messages; at (16.7) the blockchain custody system receives the signed blockchain transaction from the asset owner's biometrically enabled security device; at (16.8) the blockchain custody system sends the signed blockchain transaction to remote processors to be mined.

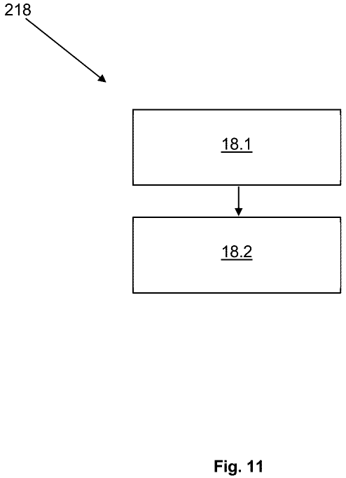

As shown in FIG. 11, the step of completing the send transaction (218) on the blockchain custody system in the method (210) of initiating an asset send transaction includes the following sequential steps: at (18.1) the blockchain transaction being sent for mining is monitored until the required threshold number of transaction confirmations have been met; at (18.2) the send transaction is marked as complete once the required number of transaction confirmations has been met.

Overall, the disclosed technology provides novel systems, devices and methods of initiating an asset send transaction which will be of particular use in a method to facilitate a blockchain transaction on a combination hardware/software custody system that is safe and secure, not vulnerable to attacks from hackers, only accessible by authorized parties and which provides adequate backup in event of failure.

### Third Embodiments

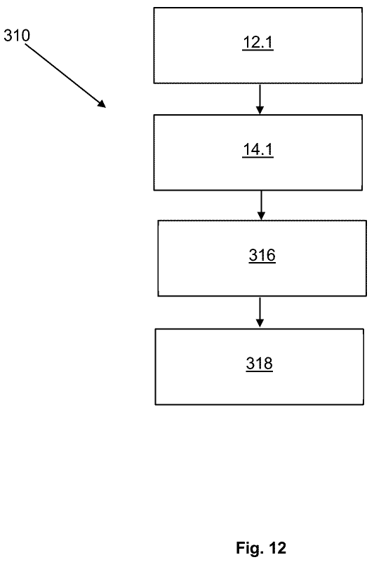

In FIG. 12 a schematic flow diagram of a method of initiating an asset receive transaction (310) in a blockchain custody system, is shown.

In the method of initiating an asset receive transaction (310), which is implemented in a blockchain custody system, the method is initiated by receiving an encrypted initiate receive transaction message at (12.1) from a remote initiator, the remote initiator being the holder of a biometrically enabled security device.

The system then receives an encrypted authorize/verify receive transaction message from at least one remote authorizer at (14.1), then executes a receive transaction on a biometrically enabled receiving security device in the blockchain custody system in accordance with the encrypted initiate receive transaction message at (316) and terminates by completing the receive transaction on the biometrically enabled receiving security device in the blockchain custody system at (318).

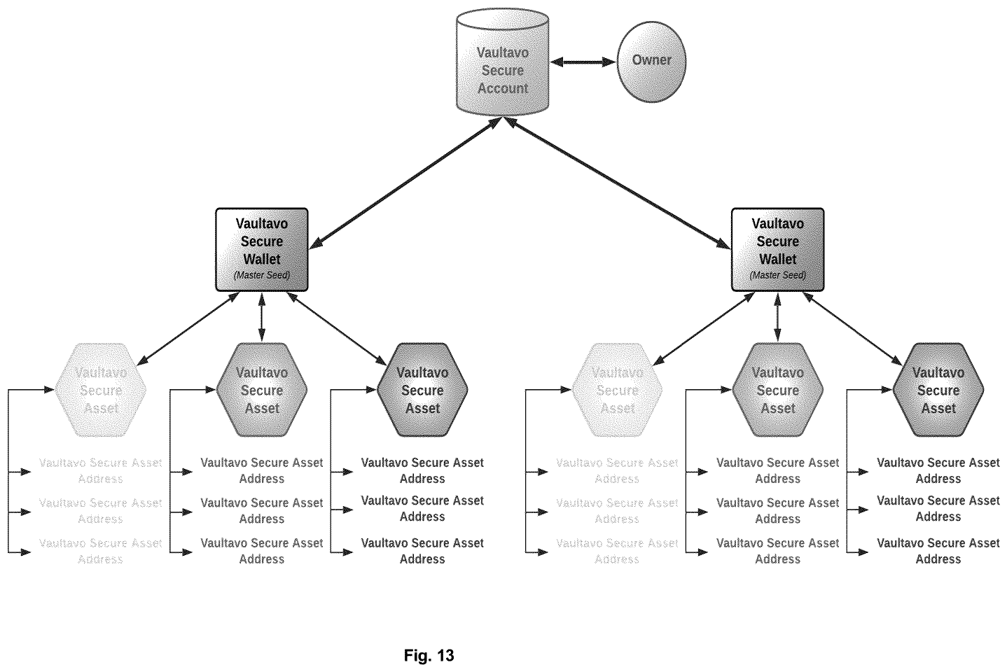

FIG. 13 shows an implementation architecture of a blockchain custody system on which the method if initiating an asset receive transaction is performed.

The method includes prior to receiving an encrypted initiate receive transaction message from a remote initiator at (12.1) the step, by a remote initiator, of initiating the asset receive transaction (not shown).

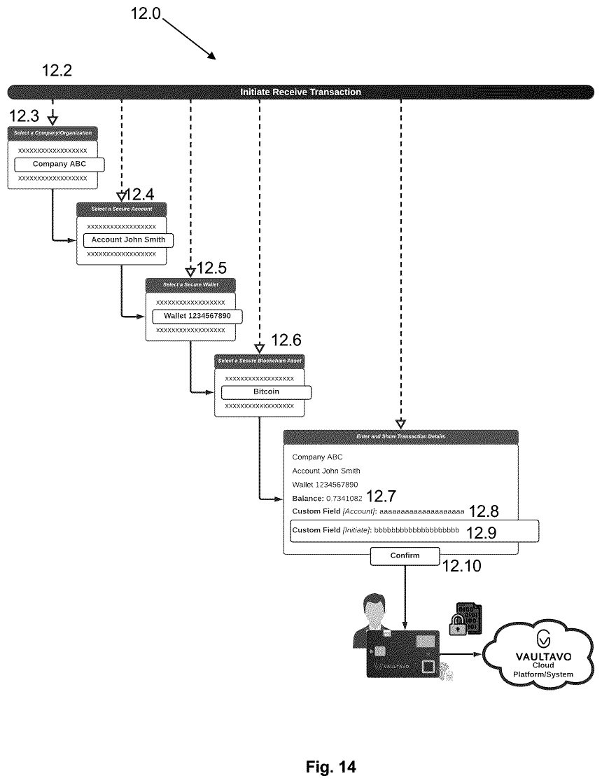

The step of initiating the asset receive transaction by a remote initiator is shown in FIG. 14 and includes the following sequential steps: at (12.2) a remote initiator logs into a custody system by means of a biometrically enabled security device; at (12.3) a remote initiator selects an organization from a list of organizations to which the remote initiator has access; at (12.4) a remote initiator selects an account from a list of accounts to which the remote initiator has access of the selected organization; at (12.5) a remote initiator selects a wallet from a list of wallets to which the remote initiator has access of the selected accounts to which the remote initiator has access; at (12.6) a remote initiator selects an asset from a list of assets to which the remote initiator has access of the selected wallets to which the remote initiator has access; at (12.7) a remote initiator is presented with a balance and any other relevant information of the selected asset; at (12.8) a remote initiator is presented with custom field values for a particular secure account and/or secure wallet and/or asset (this is an optional step in certain conditions); at (12.9) a remote initiator is presented with the opportunity of entering and/or selecting custom field values (this is an optional step in certain conditions); and at (12.10) a remote initiator confirm/authorize the asset receive transaction.

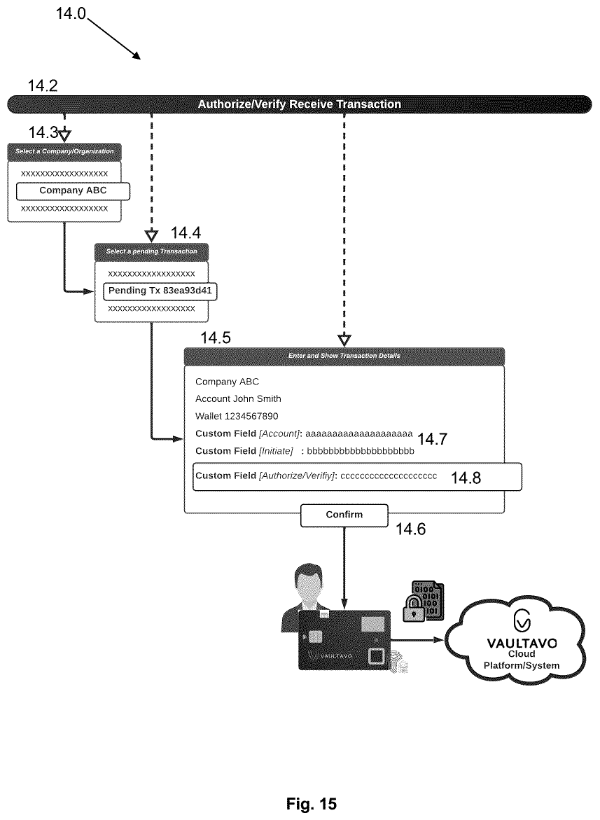

A step of authorizing the asset receive transaction (14.0) includes the following sequential steps, that are shown in FIG. 15: at (14.2) a remote authorizer logs into a custody system with a biometrically enabled security device; at (14.3) a remote authorizer selects an organization from a list of organizations to which the remote authorizer has access; at (14.4) a remote authorizer selects a pending receive transaction from a list of pending receive transactions; at (14.5) a remote authorizer view details of the selected pending receive transaction.

The step of authorizing the asset receive transaction (14.0) includes the additional (and optional) step at (14.7) of displaying custom field values to the remote authorizer. The step of authorizing the asset receive transaction also includes the (optional) step of entering and/or selecting custom field values at (14.8).

At (14.6) a remote authorizer then confirm/authorize the receive transaction.

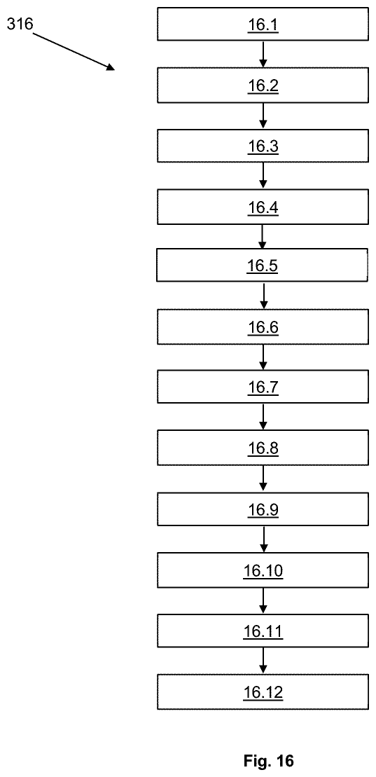

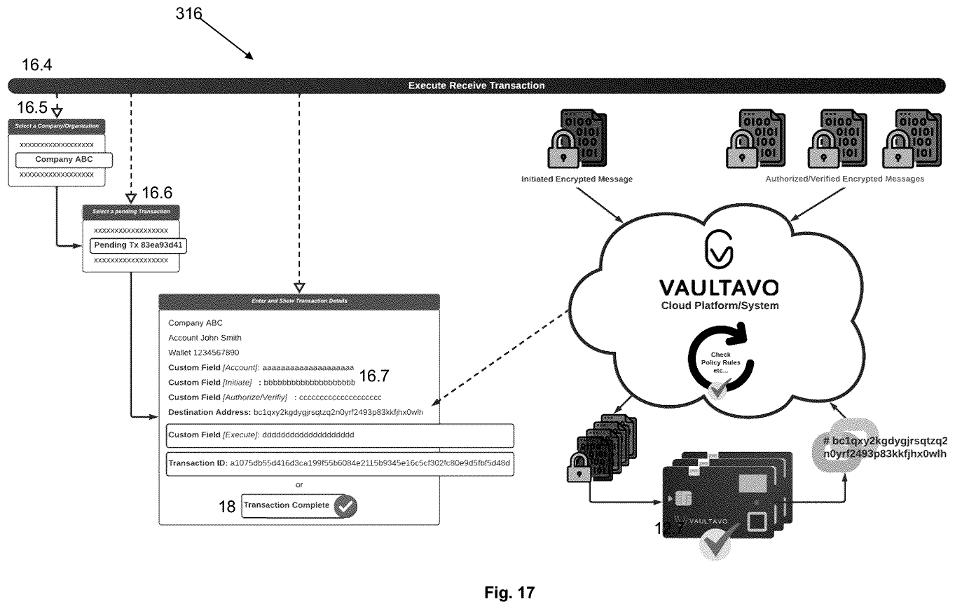

FIG. 16 shows the step of executing a receive transaction (316) in accordance with the method (310) in detail and FIG. 17 shows the step of executing a receive transaction (316) in accordance with the method (310) in summary.

An executor is defined as a role which has permission to execute a previously authorized/verified receive transaction. The step of executing a receive transaction (316) in accordance with the encrypted receive transaction message is performed by an executor.

The step of executing a receive transaction (316) in accordance with the encrypted receive transaction message includes the following sequential steps: at (16.1) the blockchain custody system receives the encrypted initiate receive transaction; at (16.2) the blockchain custody system receives the encrypted authorize verify receive transaction messages; at (16.3) the blockchain custody system (optionally) checks the receive transaction against policy rules and predefined values; at (16.4) an executor logs onto the custody system by means of a biometrically enabled security device; at (16.5) the executor selects an organization from a list of organizations to which the executor has access; at (16.6) the executor selects a pending Authorized/Verified receive transaction to execute; at (16.7) optionally, custom field values are displayed to the executor; at (16.8) details of the pending authorized receive transaction is displayed to the executor; at (16.9) the blockchain custody system sends encrypted messages and data to the biometrically enabled security device that is to receive the blockchain asset; at (16.10) the biometrically enabled security device that is to receive the blockchain asset authenticates and verifies the encrypted messages and data and checks the receive transaction against policy rules and predefined values; at (16.11) following successful authentication and verification of the encrypted messages and data, the biometrically enabled receiving security device creates a destination address(es) and returns these destination addresses to the blockchain custody system; at (16.12) optionally, the executor enter and/or selects optional custom field values for the receive transaction.

The step (318) of completing the receive transaction on the blockchain custody system in the method of initiating an asset receive transaction includes the following sequential steps: if the transaction ID was entered by the executor, monitoring the blockchain transaction being sent for mining until the required threshold number of transaction confirmations have been met; or by either marking the receive transaction as complete once the required number of transaction confirmations have been met, or automatically marking the receive transaction as complete if the executor marked the receive transaction as complete.

Overall, the disclosed technology provides provide novel systems, devices and methods of initiating an asset receive transaction which will be of particular use in a method to facilitate a blockchain transaction on a combination hardware/software custody system that is safe and secure, not vulnerable to attacks from hackers, only accessible by authorized parties and which provides adequate backup in event of failure.

1. A security device, which includes
a body complying to an ISO/IEC 7810 standard;
a security controller (SC), operable to generate at least one secure random number from a seed generated from a feature vector of a user;
a Bluetooth interface, connected to the security controller, operable to exchange data between the security controller and an external matched Bluetooth interface.

2. A security device, which includes
a plurality of security controllers, each of which is operable to generate at least one secure random number from a seed generated from a feature vector of a user;
universal asynchronous receiver/transmitter interface (UART), the interface operable to exchange data between the security controller and a matched interface device; and
one or more Micro Controller Units (MCUs), connected to the plurality of security controllers.

3. The security device of any one of claim 1 and claim 2, which includes a biometric reader, operable to generate the seed for the secure random number, the seed being generated from a feature vector of a user.

4. The security device of any one of claim 1 and claim 2, in which the user is a person and the feature vector is a homomorphically encrypted feature vector of a biometric feature of a person.

5. The security device of any one of claim 1 and claim 2, in which the security controller (SC) is a Common Criteria Evaluation Assurance Level 6+ High (CC EAL 6+ High) enabled security controller.

6. The security device of claim 3, in which the biometric reader is selected from the group of a fingerprint scanner, a face scanner and a pupil scanner.

7. The security device of claim 3, in which the biometric reader is operable to generate and verify a feature vector of a biometric feature of a person.

8. The security device of claim 3, in which the fingerprint scanner is an FCP1323 T-Shape touch sensor.

9. The security device of claim 1, in which the security device includes any one or more of an ISO/IEC 7816 compliant interface (contact interface), an ISO/IEC 14443 compliant interface (contactless interface) and a Universal Serial Bus (USB) compliant interface, universal asynchronous receiver/transmitter compliant interfaces (UART) additionally connected to the security controller, the interfaces operable to exchange data between the security controller and a matched interface device.

10. The security device of claim 9, in which any one or both of the ISO/IEC 7816 (Contact) and ISO/IEC 14443 (Contactless) interfaces are integrated into the security controller.

11. The security device of claim 1, which includes a display connected to the processor, operable to display data from the processor.

12. The security device of claim 11, in which the display is in the form of an E-Ink display.

13. The security device of any one of claim 1 and claim 2, which includes an Apple Authentication coprocessor, operable to authenticate an accessory running iOS 10.0.2 or later.

14. The security device of claim 1, which includes a Micro Controller Unit (MCU).

15. The security device of claim 14, which includes a biometric reader, a display, a USB interface, a UART interface, an Apple Authentication coprocessor and a light emitting diode (LED), in which the MCU is connected to the biometric reader, to the display, to the Bluetooth interface, to the USB/UART interface, to the Apple Authentication coprocessor and to an optional light emitting diode (LED).

16. The security device of any one of claim 1 and claim 2, in which the secure random number is in the form of an asymmetric cryptographic key pair known as Public/Private keys.

17. The security device of any one of claim 1 and claim 2, in which the seed is in the form of a homomorphically encrypted feature vector of a user.

18. The security device of any one of claim 1 and claim 2, in which the feature vector is stored in a memory of the security device, referred to as a master seed key.

19. The security device of claim 14, in which the security controller is connected to the MCU, to the ISO/IEC 7816 (Contact) interface and to the ISO/IEC 14443 (Contactless) interface.

20. The security device of claim 19, in which the security controller is arranged as the master processor and the MCU is arranged as the slave processor.

21. The security device of claim 14, in which the Micro Controller Unit (MCU) and the security controller (SC) are operable to manage the seed key and private and public key pairs, including any one of the steps of
creating, storing and using of a master seed key;
creating, storing and using blockchain private and public key pairs;
creating a backup of the master seed key;
creating a backup of feature vectors of a user;
creating a backup of feature vectors of successor users; and
retrieving a master seed key by means of the feature vector of a user.

22. The security device of claim 21, in which the MCU and SC are operable to manage the biometric scanner, including any one of the steps of
creating multiple biometric feature vectors;
enrolling multiple biometric feature vectors;
comparing scanned biometric features with previously stored biometric feature vectors; and
updating previously stored biometric features with newly scanned biometric feature vectors.

23. The security device of claim22, in which the above steps are employed for normal biometric features or for biometric features to be used during duress situations.

24. The security device of claim 22, in which the above steps are employed for biometric features of normal users or for biometric features of successors or normal users.

25. The security device of claim 22, in which the MCU and SC are operable to control transaction flow, including any one of the steps of
flow and state control of security device transactions;
application of feature vectors to transactions; and
manual authentication of transactions.

26. The security device of claim 22, in which the MCU and SC are operable to control communication with remote processors via any one of the interfaces, including any one of the steps of
creating encrypted data messages, such as hashes, digital signatures and message authentication codes (MACs);
receiving and decrypting and/or validating and/or authenticating messages and data;
generating and management of secure, once-off symmetric and/or asymmetric keys, such as Derived Unique Key Per Transaction (DUKPT) keys.

27. The security device of any one of claim 1 and claim 2, in which the security controller is operable to encrypt a data message by means of a public key in combination with a feature vector of a user.

28. The security device of claim 27, in which the security controller is operable to decrypt a data message by means of a private key in combination with a feature vector of a user.

29. The security device of claim 28, in which the data exchanged between the security controller and a matched interface includes an encryption key.

30. The security device of claim 11, in which the MCU and SC are operable to control the display.

31. The security device of claim 15, in which the MCU and SC are operable to control the interfaces.

32. The security device of claim 9, in which the MCU and SC are operable to control the communication transport layers for devices connected via the interfaces.

33. The security device of any one of claim 1 and claim 2, in which the security device is operable to run an Europay, Mastercard, Visa (EMV), Amex based payment application, operable to communicate with matched EMV enabled terminals.

34. The security device of any one of claim 1 and claim 2, which includes any one or more of a power management system, a power harvesting system and a rechargeable battery, connected to the power management system.

35. The security device of claim 1, in which the security device is operable via the Bluetooth interface to communicate with a paired Bluetooth device to exchange data between the security controller, the security device and the paired Bluetooth device.

36. The security device of claim 29, in which the security device is used in combination with an API on an external device to encrypt/decrypt data messages and to provide a feature vector of a user when requested by the external device.

37. A security module, which includes
a controller in the form of a single-board computer;
at least one Universal Serial Bus (USB)/UART hub to which a number of USB/UART devices are connectable;
an Ethernet interface to which a plurality of Ethernet devices are connectable;
a plurality of security devices as claimed in any one of claim 1 and claim 2, connected to the at least one USB/UART hub.

38. The security module of claim 1, which includes a plurality of USB/UART hubs, each of the plurality of USB/UART hubs being connectable to a plurality of USB/UART devices.

39. The security module of claim 38, in which the security devices are removably connectable to the security module.

40. The security module of claim 39, in which each of the security devices are uniquely addressable by the controller via the Ethernet interface.

41. A security vault, which includes a plurality of security modules as claimed in claim 1, connected via an Ethernet interface.

42. A method of accessing a security device as claimed in any one of claim 1 and claim 2, which includes
providing a plurality of security devices connected together;
addressing a single security device in the security vault as claimed in claim 41;
writing and reading data from the security device via an Ethernet interface and a USB/UART interface.

43. A method of initiating an asset send transaction in a blockchain custody system, which method includes
receiving an encrypted initiate send transaction message from a remote initiator, the remote initiator being the holder of a biometrically enabled security device;
receiving an encrypted authorize/verify send transaction message from a remote authorizer;
executing a sent transaction in accordance with the encrypted initiate send transaction message; and
completing the send transaction on the blockchain custody system.

44. The method of claim 43, which includes prior to receiving an encrypted initiate send transaction message from a remote initiator the step, by a remote initiator, of initiating the asset send transaction.

45. The method of claim 44, in which the step of initiating the asset send transaction by a remote initiator includes the following steps:
a remote initiator logs into a custody system;
a remote initiator selects an organization from a list of organizations to which the remote initiator has access;
a remote initiator selects an account from a list of accounts to which the remote initiator has access of the selected organization;
a remote initiator selects a wallet from a list of wallets to which the remote initiator has access of the selected accounts to which the remote initiator has access;
a remote initiator selects an asset from a list of assets to which the remote initiator has access of the selected wallets to which the remote initiator has access;
a remote initiator is presented with a balance and any other relevant information of the selected asset;
a remote initiator enters the relevant information required to which the selected asset should be transferred including, a destination address and an amount/value; and
a remote initiator confirms/authorizes the asset send transaction.

46. The method of claim 45, in which the step of initiating the asset send transaction includes the step of displaying customizable fields to a remote initiator.

47. The method of claim 45, in which the step of entering a destination address to which the selected asset should be transferred includes any one of:
entering the destination address manually;
scanning the destination address which is presented in the form of a unique visual code, such as a QR code;
selecting the destination address from a pre-populated list of destination addresses.

48. The method of claim 44, in which the step of initiating the asset send transaction includes the additional step of displaying a transaction fee and any other fees after the remote initiator entered an amount of the selected asset that should be transferred.

49. The method of claim 44, in which the step of initiating the asset send transaction includes the additional step of entering custom field values.

50. The method of claim 43, which includes, prior to receiving an encrypted authorize/verify send transaction message from a remote authorizer the step, by at least one remote authorizer, of authorizing the asset send transaction.

51. The method of claim 50, in which the step of authorizing the asset send transaction includes the following steps:
a remote authorizer logs into a custody system;
a remote authorizer selects an organization from a list of organizations to which the remote authorizer has access;
a remote authorizer selects a pending send transaction from a list of pending send transactions;
a remote authorizer views details of the selected pending send transaction; and
a remote authorizer then confirms/authorizes the send transaction.

52. The method of claim 51, in which the step of authorizing the asset send transaction includes the additional step of displaying custom field values to the remote authorizer.

53. The method of claim 51, in which the step of authorizing the asset send transaction includes the step of entering custom field values.

54. The method of claim 43, in which the step of executing a sent transaction in accordance with the encrypted initiate send transaction message includes the following steps:
the blockchain custody system receives the encrypted initiate send transaction;
the blockchain custody system receives the encrypted authorize verify send transaction messages;
the blockchain custody system checks the send transaction against policy rules and predefined values;
the blockchain custody system then sends the encrypted messages to an asset owner's biometrically enabled security device (being hosted on a security module in the blockchain custody system);
the blockchain custody system receives the signed blockchain transaction from the asset owner's biometrically enabled security device; and
the blockchain custody system sends the signed blockchain transaction to remote processors to be mined.

55. The method of claim 54, in which the step of executing a send transaction includes the intermediary steps, between the sending of the encrypted messages to the initiator's biometrically enabled security device and the receiving of the signed blockchain transaction from the asset owner's biometrically enabled security device, of
the owner's biometrically enabled security device authenticates and validates the initiator's encrypted message and other encrypted messages and checks the send transaction against policy rules and predefined values; and
the owner's biometrically enabled security device signing the blockchain transaction using the encrypted messages.

56. The method of claim 43, in which the step of completing the send transaction on the blockchain custody system in the method of initiating an asset send transaction includes the following sequential steps:
monitoring the blockchain transaction being sent for mining until the required threshold number of transaction confirmations have been met; and
marking the send transaction as complete once the required number of transaction confirmations has been met.

57. A method as claimed in claim 43, substantially as herein described and illustrated.

58. A method of initiating an asset receive transaction on a biometrically enabled receiving security device, which includes
receiving an encrypted initiate receive transaction message from a remote initiator, the remote initiator being the holder of a biometrically enabled security device;
receiving at least one encrypted authorize/verify receive transaction message from a remote authorizer;
executing a receive transaction in accordance with the encrypted initiate and authorize/verify receive transaction message on a biometrically enabled receiving security device in the blockchain custody system; and
completing the receive transaction on the biometrically enabled receiving security device in the blockchain custody system.

59. The method of claim 58 which includes prior to receiving an encrypted initiate receive transaction message from a remote initiator the step, by a remote initiator, of initiating the asset receive transaction.

60. The method of claim 59 in which the step of initiating the asset receive transaction by a remote initiator includes the following sequential steps:
a remote initiator logs into a custody system by means of a biometrically enabled security device;
a remote initiator selects an organization from a list of organizations to which the remote initiator has access;
a remote initiator selects an account from a list of accounts to which the remote initiator has access of the selected organization;
a remote initiator selects a wallet from a list of wallets to which the remote initiator has access of the selected accounts to which the remote initiator has access;
a remote initiator selects an asset from a list of assets to which the remote initiator has access of the selected wallets to which the remote initiator has access;
a remote initiator is presented with an asset balance and any other relevant information of the selected asset; and
a remote initiator confirms/authorizes the asset receive transaction on a biometrically enabled receiving security device.

61. The method of claim 60, in which the step of initiating the asset receive transaction includes the step of displaying and editing customizable fields to a remote initiator.

62. The method of claim 61, in which the step of initiating the asset receive transaction includes the additional step of displaying custom field values.

63. The method of claim 62, in which the additional step of displaying custom field values includes displaying custom field values for a particular secure account.

64. The method of claim 63, in which the step of initiating the asset receive transaction includes the additional step of entering and/or selecting custom field values after the step of displaying custom field values.

65. The method of claim 60, in which the step of authorizing the asset receive transaction includes the following sequential steps:
a remote authorizer logs into a custody system by means of a biometrically enabled security device;
a remote authorizer selects an organization from a list of organizations to which the remote authorizer has access;
a remote authorizer selects a pending receive transaction from a list of pending receive transactions;
a remote authorizer view details of the selected pending receive transaction;
a remote authorizer then confirm/authorize the receive transaction by means of a biometrically enabled security device.

66. The method of claim 65, in which the step of authorizing the asset receive transaction includes the additional step of displaying custom field values to the remote authorizer.

67. The method of claim 66, in which the step of authorizing the asset receive transaction includes the step of entering custom field values.

68. The method of claim 67, in which the step of executing a receive transaction in accordance with the encrypted initiate receive transaction message includes the following sequential steps:
the blockchain custody system receives the encrypted initiate receive transaction;
the blockchain custody system receives the encrypted authorize/verify receive transaction messages;
optionally, the blockchain custody system checks the receive transaction against policy rules and predefined values;
an executor logs onto the custody system by means of a biometrically enabled security device;
the executor selects an organization from a list of organizations to which the executor has access;
the executor selects a pending Authorized/Verified receive transaction to execute;
optionally, custom field values are displayed to the executor;
details of the pending authorized/verified receive transaction including the destination address is displayed to the executor;
optionally, the executor enters optional custom field values for the receive transaction;
the blockchain custody system sends encrypted messages and data to the biometrically enabled receiving security device (that is to receive the blockchain asset);
the biometrically enabled receiving security device authenticates and verifies all data messages and checks the receive transaction against policy rules and predefined values;
following successful authentication and verification of the encrypted messages and data, the biometrically enabled receiving security device internally creates a destination address and returns this destination address to the blockchain custody system; and
the executor generates the blockchain transaction on the relevant system.

69. The method of claim 67, in which the step of completing the receive transaction on the blockchain custody system in the method of initiating an asset receive transaction includes the following sequential steps:
if the transaction ID was entered by the executor, monitoring the blockchain transaction being sent for mining until the required threshold number of transaction confirmations have been met;
either marking the receive transaction as complete once the required number of transaction confirmations have been met, or automatically marking the receive transaction as complete if the executor marked the receive transaction as complete.

70. A system comprising:
one or more computers, processors, devices and/or computer readable media, one or more of which contain and/or are configured to execute computer-readable instructions, the computer-readable instructions comprising instructions that, when executed by at least one processor, cause the at least one processors to:
perform one or more portions, aspects and/or steps of or related to any of claims 1-69 and/or of other features or functionality set forth elsewhere in this disclosure.

71. One or more computer readable media that contain and/or are configured to execute computer-readable instructions, the computer-readable instructions comprising instructions that, when executed by at least one processor, cause the at least one processor to:
perform one or more portions, aspects and/or steps of or related to any of claims 1-69 and/or of other features or functionality set forth elsewhere in this disclosure.
